(19) United States
(12) Patent Application Publication
(10) Pub. No.: US 2006/0180337 A1
(43) Pub. Date: Aug. 17, 2006

(54) Communication cable

(76) Inventors: Harald Buthe, Nettetal (DE); Harald Heymanns, Monchengladbach (DE); Wilfried Konieczny, Ratingen (DE); Stefan Krumm, Neuss (DE)

Correspondence Address: SOFER & HAROUN, L.L.P., Suite 910, 317 Madison Avenue, New York, NY, 10017, US

(21) Appl. No.: 11/295,132

(22) Filed: Dec. 5, 2005

(30) Foreign Application Priority Data
Dec. 6, 2004 (DE) 102004058845.7

(51) Int. Cl. H01B 11/02

(52) U.S. Cl. 174/113 R

(57) ABSTRACT

The invention specifies a communication cable (K) with a large number of conductor cores (2) consisting of insulated conductors, in which the conductor cores (2) are stranded with one another to form stranded elements (1), a large number of which are combined in a cable core (8). The insulation of the conductors (3) consists of an inner layer (4) of a flameproof insulating material and an outer layer (5), which consists of a polyolefin, is produced by extrusion, and is permanently joined with the inner layer (4). A closed sheath (9) that consists of a metal strip is applied over the cable core, and the outer sheath (10), which consists of a noncombustible material, is applied over the inner sheath (9), with which it is adhesively bonded.

The invention concerns a communication cable with a large number of conductor cores consisting of insulated conductors, in which the conductor cores are stranded with one another to form stranded elements, a large number of which are combined in a cable core, and in which the cable core is surrounded by at least one sheath of insulating material.

Communication cables of this type—hereinafter referred to simply as “cables”—have long been known and are used worldwide. They are described, for example, in the technical book “Kabeltechnik” [Cable Engineering] by M. Klein, Springer Verlag 1929, pp. 224-226. Under ordinary circumstances, the cables satisfy all transmission requirements and all mechanical requirements. However, when cables are to be provided with emergency operating properties and must maintain their insulating properties in case of fire, suitable insulating materials and insulating techniques must be used, and in many cases added features must be provided. Suitable measures of this type can result in deterioration of the transmission properties of the cable.

The objective of the invention is to design a cable of the type described above in such a way that, in case of fire, it satisfies all requirements that are placed on it for safety reasons and at the same time maintains its good transmission properties unchanged.

In accordance with the invention, this objective is achieved
by providing that the insulation of the conductors consists of an inner layer of a flameproof insulating material and an outer layer, which consists of a polyolefin, is produced by extrusion, and is permanently joined with the inner layer,
by applying a closed sheath that consists of a metal strip over the cable core, and
by applying the outer sheath, which consists of a noncombustible material, over said closed inner sheath, with which it is adhesively bonded.

Noncombustible or flame-resistant and/or flameproof materials are used as insulating materials in this cable. The cable is thus noncombustible as a whole, so that it can be used to advantage, for example, in tunnels or other areas with an increased risk in the event of fire. In addition, the conductors of the conductor cores are enclosed by flameproof insulating material in the inner layer. This insulating material maintains its insulating properties in case of fire, even at high temperatures, at least for a sufficiently long time, so that the ability of the cable to function properly during this period of time is guaranteed (emergency operating behavior). In addition, it is advantageous for all insulating materials of the cable to be selected in such a way that their electrical properties allow optimum transmission of communication signals. This applies especially to the inner layer that directly surrounds the conductors of the conductor cores. For example, a material such as glass/silicone/mica, glass fibers, and/or ceramic fibers can be used for the inner layer. The outer layer that surrounds the inner layer consists of a polyolefin, whose good electrical properties are well known. Therefore, in addition to the improved safety of the cable in case of fire, its good electrical properties are also guaranteed, so that a cable of this type, on the one hand, can be connected without problems with other cables, whose structure is designed only according to predetermined electrical and transmission criteria, and, on the other hand, is suitable for higher frequencies up to 1 MHz, as are needed for the transmission of current digital signals at high bit rates.

Specific embodiments of the object of the invention are illustrated in the drawings.

FIG. 1 shows a cross section of a cable of the invention.

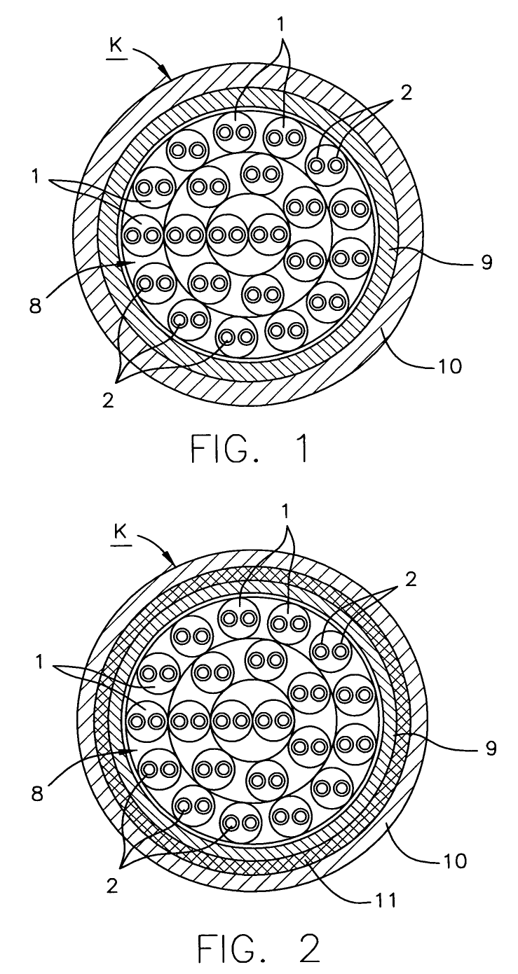

FIG. 2 shows a supplemented embodiment of the cable of FIG. 1.

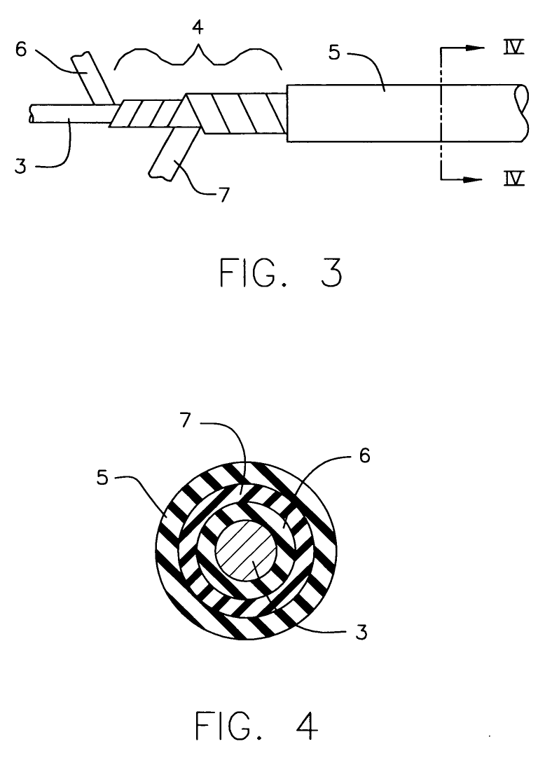

FIG. 3 shows an enlarged view of a conductor core that can be used in the cable, with layers removed in stages.

FIG. 4 shows a cross section through FIG. 3 along line IV-IV in a further enlarged view.

The cable K shown in FIGS. 1 and 2 has stranded elements 1, which consist of two conductor cores 2 that are stranded together to form a pair. Instead of these pairs, star quads customarily used in the communications field could be used as stranded elements. In star quads, four conductor cores 2 are stranded together with precise coordination. In the illustrated embodiment, the stranded elements 1 are layer-stranded in the cable K in layers that lie one above the other. For the sake of clarity, gaps are shown between the stranded elements 1. These gaps are not actually present, because the stranded elements 1 lie directly next to one another. The stranded elements 1 can also be combined in bundles in the cable core instead of with the layer stranding shown in the drawings.

As shown in FIGS. 3 and 4, each conductor core 2 has a conductor 3, which is surrounded by an inner layer 4 of a flameproof insulating material. Examples of suitable insulating materials are a material based on glass/silicone/mica, which is also known by the commercial name “Mica”, as well as materials that contain glass fibers and/or ceramic fibers. An extruded polyolefin layer 5, which can consist of polyethylene or of a halogen-free, flame-resistant mixture based on polyethylene, is applied over the inner layer 4.

The inner layer 4 has at least one strip that is wound around the conductor 3 with overlapping edges. In a preferred embodiment, this layer consists of two strips 6 and 7 that are wound around the conductor 3 with overlapping edges. The strips 6 and 7 are made of the materials specified above. In a preferred embodiment, they are wrapped around the conductor 3 in opposite directions, as shown in FIG. 3. In a preferred embodiment, the strips 6 and 7 have different widths. It is advantageous for the narrower strip 6, which directly surrounds the conductor 3, to be wrapped by the wider strip 7. The layer 5 is permanently joined with the inner layer 4, which, due to the wound strips, does not have a smooth surface. Therefore, the material of layer 5 can “interlock” with the inner layer during the extrusion process.

To produce the cable K in the illustrated embodiment, two conductor cores 2 are stranded together to form each pair of conductor cores. The conductor cores are preferably stranded with a complete (100%) backtwist. The resulting stranded elements 1 are then stranded, for example, in three layers that lie one above the other, likewise with complete backtwist, to form a cable core 8, as illustrated in FIGS. 1 and 2. The cable core 8 can also have more than three layers or only two layers. Wrappings can be applied between the individual layers of the stranded elements 1. The cable core 8 can also be surrounded by a wrapping. The stranded elements 1 can also be combined into bundles.

A closed sheath 9 consisting of metal strip is formed around the cable core 8. In a preferred embodiment, the metal strip runs in longitudinally and is wrapped around the cable core 8 with overlapping edges. It is advantageous for the overlap seam to be metallically closed. It is advantageous for the metal strip to be made of aluminum. For example, it can be realized as aluminum foil. The metal strip can be coated on one side with a copolymer coating that faces the outside in the finished cable and acts as an adhesion promoter, which becomes adhesive under the action of heat. The metal strip or sheath 9 is then adhesively bonded in a type of sandwich construction with an outer sheath 10 made of an insulating material, which is extruded onto the sheath 9. The adhesion is brought about by the heat of the extruded outer sheath 10. Adhesion between the sheath 9 and the outer sheath 10 can also be produced by applying an adhesion promoter to the sheath 9 before the outer sheath 10 is extruded.

In an advantageous refinement of the cable K, a layer of armor 11 can first be applied over the sheath 9, and then the outer sheath 10 can be applied on the armor 11, as shown in FIG. 2. In a preferred embodiment, the armor 11 consists of two steel strips, one above the other, each of which is wound with gaps. In this regard, it is advantageous for the gaps of each strip to be covered by the other steel strip.

1. Communication cable comprising:
a large number of conductor cores that are insulated conductors, in which the conductor cores are stranded with one another to form stranded elements, a large number of which are combined in a cable core, and in which the cable core is surrounded by at least one sheath of insulating material, wherein
the insulation of the conductors is an inner layer of a flameproof insulating material and an outer layer, which is made from a polyolefin, produced by extrusion, and is permanently joined with the inner layer;
a closed sheath that is a metal strip applied over the cable core; and
an outer sheath, which is an noncombustible material, applied over the inner sheath, with which it is adhesively bonded.

2. Cable in accordance with claim 1, wherein the inner layer of the insulation consists of at least one strip of flameproof insulating material wound around the conductor with overlapping edges.

3. Cable in accordance with claim 1, wherein the inner layer of the insulation consists of two strips of flameproof insulating material wound one above the other around the conductor with overlapping edges.

4. Cable in accordance with claim 3, wherein the two strips have different widths.

5. Cable in accordance with claim 3 or claim 4, wherein the two strips are wound around the conductor with different winding directions.

6. Cable in accordance with claim 1, wherein the inner layer is glass/silicone/mica.

7. Cable in accordance with claim 1, wherein the inner layer is glass fibers and/or ceramic fibers.

8. Cable in accordance with claim 1, wherein the conductor cores in the stranded elements and the stranded elements themselves are stranded with complete backtwist.

9. Cable in accordance with claim 1, wherein the extruded layer is a halogen-free, flame-resistant insulating material.

10. Cable in accordance with claim 1, wherein the metal strip of the sheath is coated on one side with a copolymer that serves as an adhesion promoter and that the coated side faces the outer sheath in the finished cable.

11. Cable in accordance with claim 1, wherein the metal strip of the sheath runs in longitudinally and is wrapped around the cable core with overlapping edges.

12. Cable in accordance with claim 1, wherein armor is applied over the sheath.

13. Cable in accordance with claim 12, wherein the armor is two steel strips, one above the other, each of which is wound with gaps, wherein the gaps of each strip are covered by the other steel strip.
